(19) United States
(12) Patent Application Publication
(10) Pub. No.: US 2014/0030500 A1
(43) Pub. Date: Jan. 30, 2014

(54) MICROLAYER BARRIER FILMS

(71) Applicants: Peter Sandkuehler, Zuerich (CH); David Munoz, San Pedro Y San Pablo (ES); Ester Baiget, Reus (ES)

(72) Inventors: Peter Sandkuehler, Zuerich (CH); David Munoz, San Pedro Y San Pablo (ES); Ester Baiget, Reus (ES)

(73) Assignee: Dow Global Technologies LLC, Midland, MI (US)

(21) Appl. No.: 14/111,695

(22) PCT Filed: Apr. 13, 2011
(86) PCT No.: PCT/EP11/55792

§ 371 Date: Oct. 14, 2013

(51) Int. Cl. B32B 27/08; B29D 7/01

(52) U.S. Cl. CPC B32B 27/08; B29D 7/01
USPC 428/216; 264/173.13

(57) ABSTRACT

The present invention relates to films comprising a number of repeating microlayer units. The repeating units include one layer made from a barrier resin derived from one or more monomers having at least one oxygen atom, and one layer comprising a non-polar polyolefin. By ensuring that the micro layers are a micron or less it has been discovered that the microlayers adequately adhere to each other without the need for a tie layer between the polar and non-polar layers.

### FIELD OF THE INVENTION

The present invention relates to films comprising a number of repeating microlayer units. The repeating units include one layer made from a barrier resin derived from one or more monomers having at least one oxygen atom, and one layer comprising a non-polar polyolefin. By ensuring that the microlayers are a micron or less it has been discovered that the microlayers adequately adhere to each other without the need for a tie layer between the polar and non-polar layers. It has also been discovered that certain of these structures are characterized by having much higher tear strength in the machine direction as compared to the cross direction. Such anisotropic tear properties may be desirable in certain applications.

### BACKGROUND AND SUMMARY OF THE INVENTION

Oxygen barrier films are used in a wide range of applications including fresh food packaging. Typical film structures are currently based on five or more coextruded layers. The core layer is typically a high barrier polymer like an ethylene vinyl alcohol resin (EVOH) or other polar material, encapsulated by layers of tie-layer resins (most commonly a maleic anhydride grafted polyethylene like AMPLIFY™ resins available from The Dow Chemical Company or competitive PLEXAR™ resins available from LyondellBasell) to provide interlayer adhesion to the two exterior polyolefin layers (most commonly linear low density polyethylene (LLDPE) or low density polyethylene (LDPE). Coextruding polar layers like EVOH and non-polar layers like LLDPE without tie-layer resins for promotion of interlayer adhesion typically results in direct delamination of the layers, meaning that the layers are easily separated. Tie-layers require additional expenditure in the purchase of specialty resins and add weight to the films, also adding expense. It would therefore be desirable to have films comprising polar and nonpolar layers which cannot be easily separated and yet do not require a tie-layer.

It has been discovered that the use of microlayer technology allows tie-layers to be eliminated from structures while maintaining adequate adherence between the layers. Accordingly, in one aspect, the present invention relates to a multilayer film or sheet comprising a microlayer sequence comprising a number, n, of repeating units, each repeating unit comprising at least two micro layers, (a) and (b), wherein (a) comprises at least 75% by weight of a polyolefin resin; and wherein (b) comprises at least 20% by weight of a second resin, said second resin being derived from one or more monomers having at least one oxygen atom, wherein the oxygen containing monomer(s) comprises at least 35 mol % of the second resin; said microlayer sequence being characterized by the absence of any tie layer between microlayers (a) and (b).

Typical cast films made of coextruded LLDPE have an Elmendorf Tear ratio between the machine direction (MD) and cross direction (CD) in the range of about 0.2 to 0.7. For some applications it would be advantageous to have films having a higher ratio such that the film could be easily torn in the cross direction. This property would be advantageous, for example in such meat packaging lines, where the films are sealed and then need to be cut off easily in cross direction. Such property may also be advantageous for easy opening packages in barrier packaging applications.

It has been discovered that films comprising microlayers of polyethylene and EVOH exhibit anisotropic tear properties. Accordingly, in another aspect, a method of producing a film having anisotropic tear properties is provided, said method comprising co-extruding a polyolefin resin and a second resin, said second resin being derived from one or more monomers having at least one oxygen atom, wherein the oxygen containing monomer comprises at least 35 mol % of the second resin. The first film through a multiplier device to form a number, n, of microlayers to form a microlayer film having a structure {(a)(b)}ₙ. It has been discovered that without a tie layer, such films can have a ratio of Elmendorf Tear in the machine direction to Elmendorf Tear in the cross direction of at least 2.0.

In some applications it may be desirable to have additional film layers on one or both sides of the microlayer film structures. Such additional film layers may provide additional functionality. For example, a peelable seal may be formed by adjusting the thickness of the external layer, particularly a polyethylene layer. Such peelable seals are another aspect of the present invention.

### DETAILED DESCRIPTION OF THE INVENTION

The present invention relates to a polymeric film structure comprising a repeating microlayer structure. The microlayer structures comprise ultra-thin polymer layers which can be designed to impart desired characteristics to the overall film structure. It has surprisingly been found that microlayers comprising oxygen-containing resins and microlayers comprising non-polar resins can sufficiently adhere to one another without the need for tie layers.

The following terms shall have the given meaning when used in the present disclosure

“Film” generally refers to materials having a thickness of 250 μm or less, and the term “sheet” to those with a thickness of more than 250 μm, but for the sake of simplicity in the present description the term “film” is used in a generic sense to include any flexible plastic article of a generally planar orientation, regardless of whether it is film or sheet.

“Inner layer” and “internal layer” refer to any film layer having both of its principal surfaces directly adhered to another layer of the film, whereas “outer layer” refers to any film layer having only one of its principal surfaces directly adhered to another layer of the film.

“Seal layer”, “sealing layer”, “heat seal layer”, and “sealant layer”, refer to the film outer layer which will be involved in the sealing of the film to close the package and that will thus be in contact with, or closer to, the packaged product.

“Tie layer” refers to any inner film layer having the primary purpose of adhering two layers to one another. Tie-layers are commonly designed to be a compatibilizing layer between given layers, and thus have aspects of each layer. For tie-layers typically used for adhering polyolefins to barrier films, relatively minor amounts of polar groups grafted onto polyolefin chains are commonly used, but copolymers of alpha-olefin with non alpha-olefins may also be used. In preferred embodiments the tie layer will comprise less than about 5 percent by weight of the oxygen-containing grafted moiety or, in the case of a copolymer, it will comprise less than 10 mol % of units derived from polar monomers.

“Machine direction”, herein abbreviated “MD”, and sometimes referred to a longitudinal direction, refers to a direction “along the length” of the film, that is, in the direction of the film as the film is formed during extrusion and/or coating.

“Cross direction”, herein abbreviated “CD”, and sometimes referred to as “transverse direction”, refers to a direction across the film, perpendicular to the machine or longitudinal direction.

When referred to an overall structure, the term “barrier” or “barrier layer” is used herein to identify material comprising at least 20% by weight of a second resin which is an oxygen-containing polymer. Preferably, such structures can be characterized by an Oxygen Transmission Rate (evaluated at 23° C. and 0% R.H. according to ASTM D-3985) of less than 300 cm³/m².day.bar. The second resin may be referred to herein as a “barrier resin” and is therefore a resin derived from one or more monomers having at least one oxygen atom, wherein the oxygen containing monomer comprises at least 35 mol % of the barrier resin. Preferably, the barrier resin is one which is capable of making a film characterized by an Oxygen Transmission Rate (evaluated at 23° C. and 0% R.H. according to ASTM D-3985) of less than 300 cm³/m².day.bar, when the resin is formed into a 50 micron thick film or film layer It will be understood by one of ordinary skill in the art that the barrier properties of the film depend on factors other than resin such as orientation, such that preferred barrier resins may not always make a film having the desired Oxygen Transmission Rate Exemplary barrier resins include, but are not limited to EVOH, Nylon, PET, nitrile (AN-MA) copolymers, thermoplastic polyesters and combinations thereof.

As used herein terms such as “polyolefin layer”, “polyamide layer” or “ethylene-vinyl alcohol layer” (or “EVOH layer”) refer to layers comprising a major proportion of the indicated layer. For example, greater than or equal to 50 wt. %, greater than or equal to 60 wt. %, greater than or equal to 70 wt. %, greater than or equal to 75%, greater than or equal to 80 wt. %, greater than or equal to 90 wt. %, greater than or equal to 95 wt. %, up to about 100 wt. %, of one or more polyolefin, barrier resin, (co)polyamides or ethylene-vinyl alcohol copolymers (or “EVOH”) respectively, said amount being calculated on the overall weight of the layer or microlayer considered.

An “oxygen-containing polymer” is a polymer which has been derived from one or more monomers having at least one oxygen atom, wherein the oxygen containing monomer(s) comprises at least 35 mol % of the polymer. By way of examples of such polar polymers there may be mentioned cellulose-based polymers, polyketones, both aliphatic and aromatic polyesters such as polymethyl or polyethyl acrylates and methacrylates and polyethylene terephthalate, vinyl alcohol/ethylene copolymers (that is to say vinyl acetate/ethylene copolymers in which at least 90% of the acetate groups have been converted into hydroxyl groups by hydrolysis or alcoholysis), aromatic polycarbonates, polyamides or nylons, and polyurethanes which, furthermore, are all well-known polymers. In some embodiments, the oxygen-containing polymers are selected from the group consisting of: ethylene vinyl acetate, aromatic polycarbonates, ethylene/carboxylic acid copolymers or acrylics.

In a first aspect of the present invention, a multilayer film is provided. The multilayer film comprises a micro layer sequence comprising a number, n, of repeating units, each repeating unit comprising at least two microlayers, (a) and (b), wherein (a) is a polyolefin layer; and wherein (b) comprises at least 20% by weight of a second resin, said second resin being derived from one or more monomers having at least one oxygen atom, wherein the oxygen containing monomer comprises at least 35 mol % of the second resin; said micro layer sequence being characterized by the absence of any tie layer between microlayers (a) and (b), such that the resulting structure has the formula [(a)(b)]ₙ. The repeating microlayer sequence may contain one or more additional layers, however, none of the additional layers in the repeating sequence should be a tie layer.

Polyolefin Layer

The polyolefin layer for use as microlayer can be any suitable polyolefin material. Preferably, the polyolefin material is derived solely from alpha-olefin monomer units. Preferably, the polyolefin comprises a polypropylene or a polyethylene material.

Suitable polypropylene materials include homopolymer polypropylene, random propylene copolymers, propylene based plastomers and elastomers (PBPEs) and impact copolymers. The propylene-based polymer can advantageously be homopolymer polypropylene or a random propylene-based copolymer (for purposes of this application, the term “copolymer” includes terpolymers). The preferred homopolymer or random copolymer polypropylene preferably has a melt flow rate (as measured according to ASTM D1238, 2.16 kg, 230° C.) of from 0.5 to 30 g/10 min, more preferably 5 to 10, most preferably greater than, or equal to, 8 to 10 g/10 min.

If homopolymer polypropylene is used, the homopolymer polypropylene can be an isotactic polypropylene homopolymer having an isotacticity of from about 89 to 99% (as measured by ¹³C NMR spectroscopy using meso pentads).

The preferred homopolymer or random copolymer polypropylene used in the polypropylene layer has a density greater than, or equal to, 0.89 g/cc and can be up to preferred maximum of 0.91 g/cm.

The preferred homopolymer or random copolymer polypropylene used in the polypropylene layer has a MWD greater than, or equal to, 2.5, preferably greater than, or equal to, 3.5.

The preferred homopolymer or random copolymer polypropylene used in the polypropylene layer of the films of the present invention may advantageously be produced using Ziegler-Natta or metallocene catalysts.

When the polyolefin layer is a polypropylene, preferably the polypropylene comprises at least 80% homopolymer polypropylene, propylene impact copolymer or random copolymer polypropylene, more preferably at least 90% homopolymer polypropylene, propylene impact copolymer or random copolymer polypropylene and can comprise all or essentially all of the polymer material used in the polyolefin layer.

Examples of suitable homopolymer polypropylene include DX5E66, or H357-09RSB produced by The Dow Chemical Company and examples of suitable random copolymer polypropylene include DS6D21, DS6D81, and INSPIRE™ 361 produced by The Dow Chemical Company and suitable examples of propylene impact copolymers include INSPIRE™ 137 also produced by The Dow Chemical Company.

If the polyolefin layer is a polypropylene layer and if that polypropylene layer comprises one or more resins other than the homopolymer propylene or random or impact copolymer polypropylene, the other resins should be selected so that they are compatible with the polypropylene material.

The polyolefin material can also advantageously comprise a polyethylene material. Suitable polyethylene materials include ethylene homopolymers and ethylene copolymers. Preferred ethylene copolymers are derived from units of ethylene and at least one C₃ to C₂₀ alpha-olefin comonomer. More preferably, the alpha-olefin comonomer comprises butene, hexene, octene or pentene. In some embodiments of this invention, the ethylene copolymer may be selected from the group consisting of LLDPE, very low density polyethylene (VLDPE), elastomers and plastomers. The ethylene copolymer may be prepared using any catalyst known in the art, including single site or metallocene catalysts. The use of a single site catalyst, including metallocene catalysts, may contribute to the improved ultimate tensile strength and puncture toughness properties of the ethylene copolymer films of this invention. In a preferred embodiment, the ethylene copolymer is a metallocene catalyzed, linear low density polyethylene (mLLDPE). Blends of two or more different ethylene copolymers are also contemplated.

When the polyolefin layer is a polyethylene, the first resin should have a density, as determined by ASTM D792, equal to or less than 0.940 g/cm³. More preferably, the density of the ethylene copolymer is equal to or less than 0.935 g/cm³, more preferably equal to or less than 0.930 g/cm³, and even more preferably less than or equal to 0.925 g/cm³. The density of the first polymer is preferably greater than or equal to 0.900 g/cm³, more preferably, greater than or equal to 0.912 g/cm³, more preferably greater than or equal 0.915 g/cm³, and even more preferably greater than or equal to 0.917 g/cm³. Further, in preferred embodiments of this invention, the ethylene copolymer has a Melt Index (as determined by ASTM D1238: 1999 190° C., 2.16 kg) ranging from 0.1 g/10 min. to 20.0 g/10 min. The first polymer also has a melting point (as determined by ISO 11357: DSC Analysis of Plastics) less than or equal to 130° C., more preferably less than or equal to 126° C.

When the polyolefin layer is a polyethylene, preferably the polyolefin layer comprises at least 80% polyethylene, more preferably at least 90% polyethylene and can comprise all or essentially all of the polymer material used in the polyolefin layer.

Examples of suitable LLDPEs and VLDPEs are DOWLEX™ 2045, 2107, 2108, ATTANE™ 4607, 4201 and 4202 (both commercially available from The Dow Chemical Company of Midland, Mich.), LL1001, LL1002, LL2001, LL3002 and LL3003.32 (commercially available from ExxonMobil Chemical Company of Baytown, Tex.). Examples of suitable mLLDPEs and mVLDPEs are EXCEED™; 1012, 1018 and 2018 metallocene polyethylenes (commercially available from ExxonMobil Chemical Company of Baytown, Tex.). And, examples of suitable plastomers and elastomers are EXACT™; 5361, 4049, 5371, 8201, 4150, 5181, 3132 ethylene plastomers (commercially available from ExxonMobil Chemical Company of Baytown, Tex.), ENGAGE™; thermoplastic polyolefin elastomers and AFFINITY™; polyolefin plastomers (both commercially available from The Dow Chemical Company of Midland, Mich.).

The polyolefin layer may contain other additives such as mineral oil or other plasticizers. Other additives generally known in the art include materials such as inorganic fillers, conductive fillers, pigments, nucleators, clarifiers, antioxidants, acid scavengers, flame retardants, ultraviolet absorbers, processing aids such as zinc stearate, extrusion aids, slip additives, permeability modifiers, anti-static agents, antiblock additives and other thermoplastic polymers.

Also, it is contemplated that combinations of two or more different polyolefins may be used in the polyolefin layer. This includes blends of two or more different polypropylenes or polyethylenes as well as blends of different polyolefins such as a blend of polypropylene and polyethylene material.

Barrier Layer

The second microlayer in the repeating sequence in the films of the present invention is a barrier layer made from a second resin, said second resin being derived from one or more monomers having at least one oxygen atom, wherein units derived from the oxygen containing monomer comprise at least 35 mol % of the second resin.

The barrier layer comprises one or more barrier polymers that markedly decrease the oxygen transmission rate through the barrier layer and thus the film incorporating the barrier layer. Useful oxygen-containing barrier polymers include oxygen-containing vinylidene chloride polymers (“PVdC”), polyolefin terephthalates, polycarbonates and ethylene/vinyl alcohol copolymers (“EVOH”).

Oxygen-containing vinylidene chloride polymers (“PVdC”) are vinylidene chloride-containing copolymers—that is, a polymer that includes at least 50 weight percent monomer units derived from vinylidene chloride (CH₂═CCl₂) together with at least 35 mol % of monomer units containing an oxygen atom, such as vinyl acetate, acrylonitrile, and C₁-C₁₂ alkyl esters of (meth)acrylic acid (e.g., methyl acrylate, butyl acrylate, methyl methacrylate). PVdC optionally includes monomer units derived from one or more of vinyl chloride orstyrene. As used herein, “(meth)acrylic acid” refers to both acrylic acid and/or methacrylic acid; and “(meth)acrylate” refers to both acrylate and methacrylate. Examples of oxygen-containing PVdC include one or more of the following: vinylidene chloride/methyl acrylate copolymer (“VDC/MA”), vinylidene chloride/ethyl acrylate copolymer, vinylidene chloride/ethyl methacrylate copolymer, vinylidene chloride/methyl methacrylate copolymer, vinylidene chloride/butyl acrylate copolymer, vinylidene chloride/acrylonitrile copolymer, and vinylidene chloride/vinyl acetate copolymer.

Useful oxygen-containing PVdC includes those having a weight-average molecular weight (M_{w}) of at least about any of the following 10,000; 50,000; 80,000; 90,000; 100,000; 111,000; 120,000; 150,000; and 180,000; and at most about any of the following: 180,000, 170,000; 160,000; 150,000; 140,000; 100,000; and 50,000. Useful oxygen-containing PVdC also includes that having a viscosity-average molecular weight (M_{z}) of at least about any of the following: 130,000; 150,000; 170,000; 200,000; 250,000; and 300,000; and at most about any of the following: 300,000; 270,000; 250,000; and 240,000.

A barrier layer that comprises oxygen-containing PVdC may also include a thermal stabilizer (e.g., a hydrogen chloride scavenger such as epoxidized soybean oil) and a lubricating processing aid (e.g., one or more polyacrylates).

Suitable resins for use in the barrier layer of the present invention also include polyolefin terephthalates such as polyethylene terephthalate and polybutylene terephthalate, and polycarbonate resins. These resins are widely available commercially and are therefore well-known in the art. Ethylene/vinyl alcohol copolymer (“EVOH”) is another barrier polymer suitable for use in the present invention. EVOH may have an ethylene content of about 32%, or at least about any of the following values: 20%, 25%, 30%, and 38% by weight. EVOH may have an ethylene content of at most about any of the following values: 50%, 48%, 40%, 35%, and 33% by weight. EVOH may include saponified or hydrolyzed ethylene/vinyl acetate copolymers, such as those having a degree of hydrolysis of at least about any of the following values: 50% and 85%. Exemplary EVOH is commercially available from Evalca Corporation having ethylene contents of 29, 32, 35, 38 and 44 mole percent.

The barrier layer comprises at least 20% by weight of the second resin. Preferably the barrier layer comprises at least 75% of the second resin, more preferably at least 90% of the second resin and for some embodiments, the barrier layer can consist of all (100%) or essentially all of the second resin.

Film Structure

The films of the present invention have a microlayer sequence comprising a number, n, of repeating units, each repeating unit comprising at least two microlayers, (a) and (b), wherein (a) is a polyolefin layer; and wherein (b) comprises at least 75% by weight of a polar resin having oxygen barrier properties; said microlayer sequence being characterized by the absence of any tie layer between microlayers (a) and (b), such that the resulting structure has the formula [(a)(b)]ₙ. Optionally, the repeating sequence may comprise one or more additional layers, (c), (d), etc., provided that such additional layers are not tie layers. For convenience these optional additional layers in the repeating structure may be referred to as “(c)” although it should be understood that (c) may represent more than one layer and that each layer of (c) may be the same or different as layer (a) or layer (b). It may be advantageous to repeat either layer (a) or (b) such that the repeating sequence might be [(a)(b)(a)]ₙ or [(b)(a)(b)]ₙ.

It is preferred that n be from 3 to 1000, more preferably from 10 to 1000, still more preferably from 15 to 1000 and most preferably from 20 to 1000

The alternating sequence may be obtained by conventional coextrusion technologies, when the number n of repeating units is limited to 3, 4 or 5, but generally and preferably the alternating sequence (a) is obtained using a multiplier device. A multiplier device is a known device that comprises a series of multiplying elements which extend from a coextrusion block connected to the extruders of the resins for the layers of the repeating unit to a final discharge die. A suitable multiplier device is depicted in FIG. 4 of WO 2009/095231, herein incorporated by reference in its entirety. In a multiplier device, the melt laminate forms a film with a number of layers dictated by the number of layers in the repeating unit (that is two or more ((a), (b), and optionally additional layers)), the number of multiplying elements and the number of ramps in each of these elements.

The layers in the resulting sequence should each have a thickness of 1 micron or less, more preferably less than or equal to 900 nanometers, still more preferably less than or equal to 750 nanometers, and most preferably less than or equal to 500 nanometers. As the layers become thicker than one micron adherence between the polyolefin layer and the polar layer becomes diminished.

The film structures of the present invention may have additional layers on one or both sides of the repeating sequence. These additional layers may provide additional functionality, such as sealability. For example, ethylene vinyl acetate (EVA) and ethylene methyl acrylate (EMA) copolymers are known to provide excellent heat sealing properties and can be made peelable with the incorporation of polybutylene or ionomers, such as SURLYN®. Propylene based elastomers or plastomers (such as the VERSIFY™ family of resins available from the Dow Chemical Company) particularly when mixed with a second polymer from a group preferably consisting of polyethylene and styrenic polymers, have a seal strength in the range that would make them particularly well suited for use as a peelable seal. Layers of LLDPE can also be used as external layers, whereupon the thickness of the external layer will determine the peel force required to open the seal. Further, it is expressly contemplated that a tie layer may be used to adhere these additional layers to the repeating microlayer structure.

The films of the present invention can be used in any application where barrier properties are desired. It has been observed that the tie-layer free microlayer structures where the polyolefin is LLDPE and the polar layer is EVOH exhibit anisotropic characteristics, in that the ratio of Elmendorf Tear (ASTM D-1922) in the machine direction to Elmendorf Tear in the cross direction is greater than or equal to 1.0, preferably greater than or equal to 1.25, more preferably greater than or equal to 1.5, still more preferably greater than or equal to 2, and most preferably greater than or equal to 2.5. Such properties would be well suited in applications such as meat packaging in which the films are sealed and then need to be cut off in the cross direction to separate the individual packages.

### EXAMPLES

Materials are summarized in Table 1. Two DOWLEX™ LLDPE resins are used, one with a melt index (MI) higher than the EVOH resin, the other with a lower MI. A HDPE resin is been also incorporated for comparison as it is known that HDPE has a better oxygen barrier than LLDPE. AMPLIFY™ GR 207 is a maleic-anhydride grafted LLDPE which is used as a tie-layer resin in some examples. It is applied in one experiment to explore its effect as a compatibilizer to EVOH in a dry blend with a DOWLEX™ LLDPE.

TABLE 1
Characterization of resins used.

| Resin | Melt index (MI2) | density | Comment |
|---|---|---|---|
| Resin 1 | 2.3 | 0.917 | Z-N LLDPE |
| Resin 2 | 1.05 | 0.919 | Z-N LLDPE |
| Resin 3 (Amplify | 2.1 | 0.9215 | <0.25% MAH |
| GR 207) | | | |
| Resin 4 (Eval | 1.8 | 1.19 | EVOH, 23 mol % |
| F171B) | | | Ethylene |
| Resin 5 | 2 | 0.956 | Slurry HDPE |
| Resin 6 | 7 | 0.900 | Random PP |
| Resin 7 (PC, | MI 23 measured at | | Polycarbonate |
| CALIBRE 300-23) | 300° C. and 1.2 kg | | |
| Resin 8 (UBE Nylon | Relative viscosity | 1.14 | Polyamide 6/6.6 |
| 5033B) | (96% H₂SO₄; | | |
| | 0 g/100 ml)) JIS | | |
| | K6810 = 4.06 | | |
| Resin 9 | 1.8 | 0.900 | Random PP |

Films are made on a Dr Collin Coex five layer Cast line equipped with 4 extruders (ABCBD). Extruder B is split into two melt streams encapsulating the melt from extruder C in the feedblock, followed by multipliers (8×) and a cast die of 300 mm. The air gap is maintained at 14 mm and the chill role angle is 3.2. The die gap was held constant at 0.7 mm. The chill roll temperature is 18° C. The films have a total thickness of 25 micron (1 mil).

TABLE 2
Film description

| | | | Material for | Layer Weight |
|---|---|---|---|---|
| | Material | Material | Layer B (100 | Percentages |
| | for Layers | for Layers | wt %, unless | (A/B(cumu- |
| Example | A, & D | C | otherwise noted) | lative)C/D |
| Comp. 1 | Resin 1 | Resin 1 | Resin 1 | 24/28/24/24 |
| Comp. 2 | Resin 1 | Resin 1 | Resin 5 | 18/46/18/18 |
| Comp 3 | Resin1 | Resin1 | 95% Resin 1 + | 18/55/10/18 |
| | | | 5% Resin 4 | |
| E4 | Resin 1 | Resin 1 | 80% Resin 1 + | 33/19/15/33 |
| | | | 20% Resin 4 | |
| E5 | Resin 1 | Resin 1 | Resin 4 | 33/19/15/33 |
| Comp. 6 | Resin 2 | Resin 2 | Resin 2 | 24/28/24/24 |
| E7 | Resin 2 | Resin 2 | Resin 4 | 24/28/24/24 |
| E8 | Resin 2 | Resin 2 | 80% Resin 2 + | 24/28/24/24 |
| | | | 20% Resin 4 | |
| E9 | Resin 2 | Resin 2 | 60% Resin 2 + | 24/28/24/24 |
| | | | 40% Resin 4 | |
| E10 | Resin 2 | Resin 2 | 58% Resin 2 + | 24/28/24/24 |
| | | | 40% Resin 4 + | |
| | | | 2% Resin 3 | |
| E11 | Resin 1 | Resin 1 | Resin 4 | 30/10/30/30 |
| E12 | Resin 1 | Resin 1 | Resin 4 | 38/12/12/38 |
| E13 | Resin 1 | Resin 1 | Resin 4 | 33/19/15/33 |
| E14 | Resin 1 | Resin 1 | Resin 4 | 24/28/24/24 |
| E15 | Resin 1 | Resin 1 | Resin 4 | 30/30/10/30 |
| E16 | Resin1 | Resin 4 | Resin 1 | 24/42/10/24 |
| E17 | Resin1 | Resin 4 | Resin 1 | 24/33/19/24 |
| E18 | Resin6 | Resin6 | Resin 4 | 30/10/30/30 |
| E19 | Resin6 | Resin6 | Resin 4 | 25/25/25/25 |
| E20 | Resin6 | Resin6 | Resin 4 | 29/14/28/29 |
| E21 | Resin 1 | Resin 1 | Resin7 | 25/25/25/25 |
| E22 | Resin2 | Resin2 | Resin7 | 29/14/28/29 |
| E23 | Resin1 | Resin1 | Resin 7 | 29/14/28/29 |
| E24 | Resin9 | Resin9 | Resin 7 | 29/14/28/29 |
| Comp 25 | Resin1 | Resin1 | Resin 8 | 29/14/28/29 |
| 26 | Resin1 | Resin8 | Resin1 | 29/14/28/29 |
| E27 | Resin1 | Resin8 | Resin4 | 29/14/28/29 |

Film samples are collected and tested for the following properties:

Haze—ISO 14782

Clarity—ASTM D1746

Gloss 45°—ASTM D-2457-90

Elmendorf tear MD, CD—ASTM D-1922

Puncture—ASTM D-5748

WVTR—Tappi T 523 om-02

Oxygen transmission rate—ASTM D-3985

Tensile MD—ISO 527—3/2000

The results are summarized in Table 3, 4 and 5. In addition, the films are subjected to manual abuse testing by twisting, bending, tearing, and stretching, but no visible delamination between the layers could be forced.

Measuring tensile properties on sample 376661, containing in layers B 100% EVOH, a maximum strain of 180%, a tensile strength of 44 MPa, and a toughness of 58.61 N·mm/mm³ was measured. Observing the film specimen during the tensile test, no delamination, change in clarity or layer breakup was noticed. Importantly, the tensile strength of the film is characteristic of DOWLEX SC2107G (˜40 MPa) versus <34 MPa (600 kg/cm²) for EVOH, and the elongation at break is rather characteristic for EVOH (<230%) than for DOWLEX SC2107G with >400%. Delamination of EVOH and LLDPE is expected to cause the composite to elongate rather like a LLDPE. However, the interlayer adhesion seems sufficiently strong to cause failure of the whole film when the EVOH layers are maximally elongated.

We estimate the thickness of the individual functional layer (EVOH or HD) by t=T*lp/2/8, where T is the total film thickness, lp is the layer percentage of B in Table 2, split by 2 and multiplied by 8 (Table 2):

TABLE 3
Film Properties

| | | | | | | Oxygen | | | | | |
|---|---|---|---|---|---|---|---|---|---|---|---|
| | | | | | | Transmission | | | | | Water Vapor |
| | | Elmendorf | Elmendorf | | | Rate | Puncture | Puncture | Puncture | Puncture | Transmission |
| | | Tear CD | Tear MD | Gloss | Haze | (cc_Oxygen/ | Elongation | Energy | Force | Resistance | Rate |
| Example # | Clarity (%) | (g) | (g) | (%) | (%) | sq_m/day) | (mm) | (J) | (N) | (J/cm³) | (g/sq_m/day) |
| Comp 1 | 99.6 | 460 | 243 | 92.2 | 0.9 | 13309 | 142.5 | 30 | 41.0 | 16.0 | 19.5 |
| Comp 2 | 97.2 | 917 | 37.4 | 76.5 | 4.6 | 8500 | 83.2 | 1.7 | 37.1 | 9.0 | 12.9 |
| Comp 3 | 92.9 | 276 | 65.5 | 89.1 | 2.9 | 11337 | 102.7 | 1.9 | 35.1 | 8.7 | 17.9 |
| E4 | 74.4 | 385 | 97.2 | 78.1 | 8.4 | 7149 | 106.5 | 1.9 | 36.0 | 8.8 | 19.4 |
| E5 | 123 | 123 | 325 | 94.2 | 0.6 | 20 | 56.75 | 1.3 | 45.2 | 6.0 | 15.9 |
| Comp 6 | 99.6 | 588 | 383 | 90.9 | 1.1 | 13389 | 154.8 | 4.9 | 60.8 | 25.3 | 17.9 |
| E7 | | 211 | 126 | 65.1 | 13.6 | 5.7 | 49.3 | 1.1 | 45.0 | 5.5 | 18.8 |
| E8 | 58.5 | 567 | 98.8 | 61.3 | 17.4 | 3009 | 91.1 | 1.3 | 30.7 | 6.0 | 21.5 |
| E9 | 57 | 509 | 53.3 | 59.8 | 18.2 | 20.7 | 65.9 | 1.1 | 37.6 | 4.5 | 16.8 |
| E10 | 53.8 | 546 | 122 | 55.8 | 26.3 | 23.9 | 75.1 | 1.1 | 33.2 | 4.7 | 17.7 |

TABLE 4

| | | Sample | | | | | | |
|---|---|---|---|---|---|---|---|---|
| | | E11 | E12 | E13 | E14 | E15 | E16 | E17 |
| Delamination | | no | no | no | no | no | no | no |
| when unwinding | | | | | | | | |
| Die gap | mm | 0.70 | 0.70 | 0.70 | 0.70 | 0.70 | 0.70 | 0.70 |
| Layer Percentage - Ext. A | % | 30.00 | 38.00 | 33.00 | 24.00 | 30.00 | 24.00 | 24.00 |
| Layer Percentage - Ext. B | % | 10.00 | 12.00 | 19.00 | 28.00 | 30.00 | 42.00 | 33.00 |
| Layer Percentage - Ext. C | % | 30.00 | 12.00 | 15.00 | 24.00 | 10.00 | 10.00 | 19.00 |
| Layer Percentage - Ext. D | % | 30.00 | 38.00 | 33.00 | 24.00 | 30.00 | 24.00 | 24.00 |
| Impact | g | 184.00 | 178.00 | 185.00 | 169.00 | 120.00 | 201.00 | 211.00 |
| Average Elmendorf CD | g | 337.00 | 230.00 | 190.00 | 380.00 | 180.00 | 205.00 | 89.10 |
| Average Elmendorf MD | g | 234.00 | 324.00 | 475.00 | 871.00 | 742.00 | 278.00 | 384.00 |
| Average Gloss | Gloss | 93.50 | 92.80 | 93.60 | 94.40 | 94.00 | 92.90 | 92.70 |
| Average Haze | % | 0.40 | 0.50 | 0.50 | 0.40 | 0.40 | 0.60 | 0.50 |
| Average Thickness | um | 25.90 | 26.30 | 26.20 | 25.20 | 25.90 | 25.50 | 25.50 |
| Oxygen Transmission Rate | ccO2/sqm/d | 8.72 | 49.57 | 45.11 | 30.06 | 22.52 | 32.11 | 29.13 |
| Puncture Elongation | mm | 117.70 | 97.78 | 85.71 | 79.98 | 70.24 | 116.00 | 67.51 |
| Puncture Energy | J | 3.31 | 2.45 | 2.23 | 2.16 | 1.93 | 3.21 | 1.63 |
| Puncture Force | N | 49.30 | 47.06 | 49.68 | 52.54 | 53.22 | 50.02 | 45.65 |
| Puncture Resistance | J/cm\hat{ }3 | 15.58 | 11.91 | 11.02 | 10.83 | 9.77 | 16.11 | 8.04 |
| Strain at Break | % | 352.46 | 382.06 | 253.84 | 170.04 | 188.75 | 424.95 | 222.82 |
| Strain at Tensile Strength | % | 347.84 | 375.08 | 251.90 | 168.16 | 187.38 | 419.49 | 221.61 |
| Strain at Yield | % | 8.56 | 35.50 | 4.93 | 3.96 | 4.33 | 54.00 | 4.95 |
| Stress at Break | MPa | 30.27 | 28.57 | 35.40 | 38.07 | 39.84 | 28.65 | 36.19 |
| Stress at Yield | MPa | 8.81 | 10.00 | 13.80 | 18.30 | 18.30 | 9.54 | 14.60 |
| Tensile Strength | MPa | 30.59 | 29.10 | 35.53 | 38.80 | 40.35 | 29.16 | 36.55 |
| Toughness | MJ/m\hat{ }3 | 71.33 | 76.42 | 60.72 | 46.64 | 52.32 | 81.84 | 56.53 |

TABLE 5

| | | Sample | | | | | | | | | |
|---|---|---|---|---|---|---|---|---|---|---|---|
| | | E18 | E19 | E20 | E21 | E22 | E23 | E24 | C25 | C26 | E27 |
| Delamination | | no | no | no | no | no | no | no | Yes | Yes | No |
| when unwinding | | | | | | | | | | | |
| Die gap | mm | 0.7 | 0.7 | 0.7 | 0.7 | 0.7 | 0.7 | 0.7 | 0.7 | 0.7 | 0.7 |
| Layer Percentage - Ext. A | % | 30 | 25 | 29 | 25 | 29 | 29 | 29 | 29 | 29 | 29 |
| Layer Percentage - Ext. B | % | 10 | 25 | 14 | 25 | 14 | 14 | 14 | 14 | 14 | 14 |
| Layer Percentage - Ext. C | % | 30 | 25 | 28 | 25 | 28 | 28 | 28 | 28 | 28 | 28 |
| Layer Percentage - Ext. D | % | 30 | 25 | 29 | 25 | 29 | 29 | 29 | 29 | 29 | 29 |
| Impact | g | 25 | 50 | 50 | 371 | 180 | 275 | 50 | | | 622 |
| Average Elmendorf | g | 916 | 1790 | 1310 | 5.04 | 15 | 13.4 | 24.2 | 207 | 595 | 49.1 |
| Average Elmendorf | g | 51 | 46.6 | 33.1 | 4.1 | 8.55 | 6.44 | 5.27 | 70.9 | 211 | 74.4 |
| Average Gloss | Gloss | | 89.9 | 89.3 | 106.2 | 59 | 94.7 | 40.5 | | | 93.6 |
| Average Haze | % | | 1 | 1.1 | 0.9 | 34.4 | 0.9 | 50.3 | | | 0.4 |
| Average Thickness | um | 25.5 | 25.6 | 25.6 | 25.3 | | 25.5 | | 26.1 | 25.6 | |
| Oxygen Transmission Rate | ccO2/sqm/d | 4.03 | 41.16 | 65.14 | 6453.1 | | 9638.9 | | 424.61 | 727.3 | |
| Puncture Elongation | mm | | 53.48 | 63.57 | 35.13 | 37.38 | 34.46 | 34.86 | | | 109.4 |
| Puncture Energy | J | | 1.093 | 1.317 | 0.609 | 0.546 | 0.433 | 0.311 | | | 3.68 |
| Puncture Force | N | | 39.32 | 38.44 | 43.24 | 34.27 | 31.86 | 18.4 | | | 65.86 |
| Puncture Resistance | J/cm\hat{ }3 | | 5.466 | 6.606 | 3.083 | 2.597 | 2.073 | 1.561 | | | 18.02 |

Although the invention has been described in considerable detail through the preceding description and examples, this detail is for the purpose of illustration and is not to be construed as a limitation on the scope of the invention as it is described in the appended claims. All United States patents, published patent applications and allowed patent applications identified above are incorporated herein by reference.

1. A multilayer film or sheet comprising:
a microlayer sequence comprising a number, n, of repeating units, each repeating unit comprising at least two microlayers, (a) and (b), wherein (a) is a first resin derived solely from one or more alpha-olefinic mononomers; and wherein (b) comprises at least 20% by weight of a second resin derived from one or more monomers having at least one oxygen atom, wherein the oxygen containing monomer comprises at least 35 mol % of the second resin, said microlayer sequence being characterized by the absence of any tie layer between microlayers (a) and (b), such that the resulting structure has the formula {(a)(b)(c)}ₙ, where (c) represents one or more optional additional layers which may be the same or different from layers a and b, but which are not tie layers;
and wherein each of the layers (a) and (b) are one micron or less in thickness.

2. The multilayer film or sheet of claim 1 further comprising one or more additional layers on at least one side of the microlayer sequence.

3. The multilayer film or sheet of claim 1 wherein the polyolefin resin is a linear low density polyethylene (LLDPE) resin.

4. The multilayer film or sheet of claim 1 wherein the polar resin is ethylene vinyl alcohol (EVOH)

5. The multilayer film or sheet of claim 1 wherein microlayer (a) and microlayer (b) each have a thickness of 900 nanometers or less.

6. The multilayer film or sheet of claim 1 wherein n is from 3 to 1000.

7. A method of producing a film having anisotropic tear properties is provided, said method comprising
a) co-extruding a polyolefin resin and a polar resin having oxygen barrier properties to form a first film;
b) sending the first film through a multiplier device to form a number, n, of microlayers to form a microlayer film having a structure {(a)(b)}ₙ, and wherein each of the layers (a) and (b) are one micron or less in thickness;
wherein said film has a ratio of Elmendorf Tear in the machine direction to Elmendorf Tear in the cross direction of at least 2.0

8. The multilayer film of claim 1 where layer c is present and comprises the same material as a.

9. The multilayer film of claim 1 wherein microlayer (b) comprises at least 75% by weight of the second resin.

10. The multilayer film of claim 1 wherein microlayer (b) comprises at least 99% by weight of the second resin.
